(19) United States
(12) Patent Application Publication
(10) Pub. No.: US 2026/0360885 A1
(43) Pub. Date: Nov. 12, 2026

(54) BATTERY

(71) Applicant: Panasonic Energy Co., Ltd., Moriguchi-shi, Osaka (JP)

(72) Inventor: Ryota OKIMOTO, Osaka (JP)

(21) Appl. No.: 19/124,035

(22) PCT Filed: Sep. 20, 2023
(86) PCT No.: PCT/JP2023/034053

§ 371 Date: Apr. 24, 2025

(30) Foreign Application Priority Data
Oct. 27, 2022 (JP) 2022-172133

(51) Int. Cl. H01M 50/184; H01M 50/109; H01M 50/167; H01M 50/181; H01M 50/188; H01M 50/191

(52) U.S. Cl. CPC H01M 50/184; H01M 50/109; H01M 50/167; H01M 50/181; H01M 50/188; H01M 50/191

(57) ABSTRACT

A battery includes a case, an electrode group housed therein and including a first electrode and a second electrode, and a sealing unit that seals the opening of the case. The case includes a crimped part that fixes the sealing unit, and is electrically connected to the first electrode. The sealing unit includes a current collector plate electrically connected to the second electrode, a conductive cap provided outward of the current collector plate in the axial direction of the case and joined to the current collector plate at a first joint, an insulative gasket provided between the crimped part and the current collector plate and the conductive cap, and an insulating member including a first insulating portion 56a located between the peripheral edge of the current collector plate and the peripheral edge of the conductive cap. The first insulating portion is provided outward of the first joint.

### TECHNICAL FIELD

The present disclosure relates to a battery.

### BACKGROUND ART

Batteries that can be used through repeated charging and discharging have been known conventionally (e.g., Patent Literature 1). The battery of Patent Literature 1 includes a bottomed cylindrical case having an opening at one end, an electrode group housed in the case and including a first electrode and a second electrode, and a sealing unit that seals the opening of the case. The sealing unit includes a sealing body formed by stacking a filter, a lower valve body, an insulator, an upper valve body, and a cap in the stated order from the side of the electrode group, and a gasket provided between the case and the sealing body.

### CITATION LIST

### Patent Literature

Patent Literature 1: Japanese Laid-Open Patent Publication No. 2019-153388

### SUMMARY OF INVENTION

### Technical Problem

Incidentally, a battery may combust when an abnormality occurs. When combustion occurs, the gasket may melt by the heat to allow the components of the sealing body and the case to be in electrical contact with each other. Such electrical contact or an internal short circuit is particularly problematic in a battery pack including a plurality of the batteries. This is because a large amount of current flows from the other batteries to the battery in which combustion has occurred to lower the output power of the battery pack. In view of such a circumstance, the object of the present disclosure is to inhibit an internal short circuit in combustion.

### Solution to Problem

One aspect of the present disclosure relates to a battery. The battery includes: a case with a bottomed cylindrical shape having an opening at one end thereof; an electrode group housed in the case and including a first electrode and a second electrode; and a sealing unit that seals the opening, wherein the case includes a crimped part that fixes the sealing unit, and is electrically connected to the first electrode, the sealing unit includes: a current collector plate electrically connected to the second electrode; a conducive cap provided outward of the current collector plate in an axial direction of the case and joined to the current collector plate at a first joint; a gasket that is insulative and that is provided between the crimped part and the current collector plate and the conductive cap; and an insulating member including a first insulating portion located between a peripheral edge of the current collector plate and a peripheral edge of the conductive cap, and the first insulating portion is provided outward of the first joint.

### Advantageous Effects of Invention

According to the present disclosure, an internal short circuit in combustion can be inhibited.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic cross-sectional view of an example of a battery according to the present disclosure.

FIG. 2 is an enlarged cross-sectional view of main components of the battery of FIG. 1.

FIG. 3 is a conceptual diagram explaining a short circuit inhibiting function of the battery according to the present disclosure.

### DESCRIPTION OF EMBODIMENTS

Embodiments of a battery according to the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained.

The battery according to the present disclosure may be a primary battery such as a lithium primary battery, or may be a secondary battery such as an alkaline storage battery (e.g., a nickel-hydrogen battery or a nickel-cadmium battery), a lithium-ion secondary battery, or a lithium-metal secondary battery. In the present disclosure, power storage devices (e.g., a lithium-ion capacitor) in which at least one of the positive electrode and the negative electrode is an electrode that expresses its capacity by the Faraday reaction also belong to the category of the secondary battery.

The battery according to the present disclosure includes a case, an electrode group, and a sealing unit. Although the type of the battery is not particularly limited as described above, a case of a lithium-ion secondary battery will be mainly described below.

The case is formed in a bottomed cylindrical shape with an opening at one end thereof. The case may have a bottomed cylindrical shape or a bottomed prismatic shape. The case may be constituted of a conductor (e.g., a metal containing iron as a main component or a metal containing aluminum as a main component).

The electrode group is housed in the case, and includes a first electrode and a second electrode. The electrode group may be a wound electrode group of the first electrode and the second electrode, wound with a separator therebetween. The outer shape of the electrode group may be cylindrical or prismatic, for example. One of the first electrode and the second electrode is a positive electrode, while the other of the first electrode and the second electrode is a negative electrode.

The first electrode may include a first current collector having a long sheet-like shape and a first active material layer formed on a surface of the first current collector. When the first electrode is the negative electrode of a lithium-ion secondary battery, the first current collector may be constituted of a copper foil or a copper alloy foil. When the first electrode is the negative electrode of a lithium-ion secondary battery, the first active material layer may contain a negative electrode active material (e.g., a carbonaceous material or a silicon-containing material), a conductive agent, and a binder, for example. Note that the first active material layer may not be provided.

The second electrode may include a second current collector having a long sheet-like shape and a second active material layer formed on a surface of the second current collector. When the second electrode is the positive electrode of a lithium-ion secondary battery, the second current collector may be constituted of an aluminum foil or an aluminum alloy foil. When the second electrode is the positive electrode of a lithium-ion secondary battery, the second active material layer may contain a positive electrode active material (e.g., a lithium-containing transition metal oxide), a conductive agent, and a binder, for example.

The separator may be constituted of a porous sheet having ionic permeability and insulating properties. Examples of the porous sheet include a thin film having micropores, a woven fabric, and a nonwoven fabric.

The case includes a crimped part that fixes the sealing unit. The case is electrically connected to the first electrode of the electrode group. In the above configuration, the case functions as one of external terminals of the battery.

The sealing unit seals the opening of the case. The sealing unit includes a current collector plate, a conductive cap, a gasket that is insulative, and an insulating member. The current collector plate is electrically connected to the second electrode of the electrode group. The conductive cap is provided outward of the current collector plate in the axial direction of the case, and is joined to the current collector plate at a first joint. In the above configuration, the conductive cap functions as the other of the external terminals of the battery. The gasket is provided between the crimped part and the current collector plate and the conductive cap. The gasket may be constituted of polypropylene, for example. The insulating member includes a first insulating portion provided between the peripheral edge of the current collector plate and the peripheral edge of the conductive cap. The first insulating portion is located outward of the first joint.

The first insulating portion is desirably constituted of a material having a heat resistance higher than that of the gasket. For example, the first insulating portion may contain a resin material having a melting point or load deflection temperature higher than that of the gasket as a main component, may contain ceramics as a main component, or may be constituted of a cured product of a thermosetting resin composition. The load deflection temperature should be measured by load deflection temperature measurement in accordance with the standard test method ASTM-D648 defined by the American Society for Testing and Materials. The main component may be a component constituting 50% by mass or more of the first insulating portion, or may be a component constituting 70% by mass or more. The insulating member including the first insulating portion may be constituted of, for example, polyphenylene sulfide or a copolymer of ethylene tetrafluoride and perfluoroalkoxyethylene from the point of view of high sealing properties and high heat resistance.

Here, when combustion occurs in the battery, the gasket may melt to allow the conductive components (especially, the current collector plate) of the sealing unit to come into contact with the crimped part of the case, leading to an internal short circuit. To tackle this, the sealing unit according to the present disclosure includes the insulating member including the first insulating portion on the inner side of the gasket, in a position where it is less likely to combust. The first insulating portion such as above is difficult to be melted or combusted even during battery combustion. Provision of the first insulating portion between the peripheral edge of the current collector plate and the peripheral edge of the conductive cap keeps the conductive cap insulated from the current collector plate and the case even when the current collector plate comes in contact with the crimped part of the case. It should be noted that the joined stated of the first joint between the current collector plate and the conductive cap can be released by either or both heat of combustion and thermal expansion of the first insulating portion during battery combustion. Thus, an internal short circuit in combustion can be inhibited.

The insulating member may further include a second insulating portion extending in the axial direction of the case from the outer peripheral end of the first insulating portion and located between the conductive cap and the gasket. That is, the second insulating portion is located radially outward of the peripheral edge of the conductive cap, and a portion of the gasket is present at a position further radially outward of the second insulating portion. The second insulating portion may contain a resin material having a melting point or load deflection temperature higher than that of the gasket as a main component, may contain ceramics as a main component, or may be constituted of a cured product of a thermosetting resin composition. In the above configuration, the peripheral edge of the conductive cap can be prevented from coming into contact with the crimped part of the case in the presence of the second insulating portion even when the gasket located radially outward of the peripheral edge of the conductive cap melts in battery combustion.

The insulating member may further include a third insulating portion extending radially inward of the case from an end of the second insulating portion and located between the conductive cap and the gasket. That is, the third insulating portion is located axially outward of the peripheral edge of the conductive cap, and a portion of the gasket is present at a position further axially outward of the third insulating portion. The third insulating portion may contain a resin material having a melting point or load deflection temperature higher than that of the gasket as a main component, may contain ceramics as a main component, or may be constituted of a cured product of a thermosetting resin composition. In the above configuration, the peripheral edge of the conductive cap can be prevented from coming into contact with the crimped part of the case in the presence of the third insulating portion even when the gasket located axially outward of the peripheral edge of the conductive cap melts in combustion.

The insulating member may be constituted of a thermal expansion material having a linear expansion coefficient at 25 °C of 2.0×10⁻⁵/K or more. In this case, the first insulating portion greatly expands during battery combustion, and as a result, the joining state of the first joint is easily released. Therefore, even if a portion of the current collector plate corresponding to the first joint is not melted by heat of combustion, the current collector plate and the conductive cap easily electrically insulated from each other.

Given that D represents the radial distance from the outer peripheral edge of the conductive cap to the first joint, the radial distance from the outer peripheral edge of the conductive cap to the inner peripheral end of the first insulating portion may be 0.25 D or more. In the above configuration, the inner peripheral end of the first insulating portion is located relatively close to the first joint. In the above configuration, expansion of the first insulating portion during battery combustion facilitates easy separation of the current collector plate and the conductive cap from each other at the first joint to easily release the joining state of the first joint. The radial distance from the outer peripheral edge of the conductive cap to the inner peripheral end of the first insulating portion may be 0.4 D or more, 0.5 D or more, 0.6 D or more, 0.7 D or more, 0.8D or more, or 0.9 D or more.

As described above, according to the present disclosure, provision of the insulating member at a position that is less likely to be combusted than the gasket can make it possible to inhibit an internal short circuit in battery combustion.

Hereinafter, an example of the battery according to the present disclosure will be described in detail with reference to the drawings. The above-described elements of configuration can be applied to the elements of configuration of the exemplary battery described below. The elements of configuration of the exemplary battery described below can be altered based on the above description. Further, the matters described below may be applied to the above-described embodiments. Among the elements of configuration of the exemplary battery described below, an element of configuration that is not essential to the battery according to the present disclosure may be omitted. It should be noted that the drawings indicated below are schematic and do not accurately reflect the shape or number of actual members.

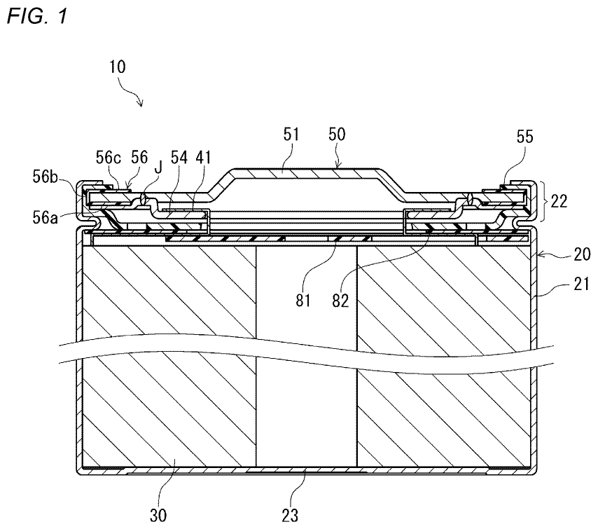

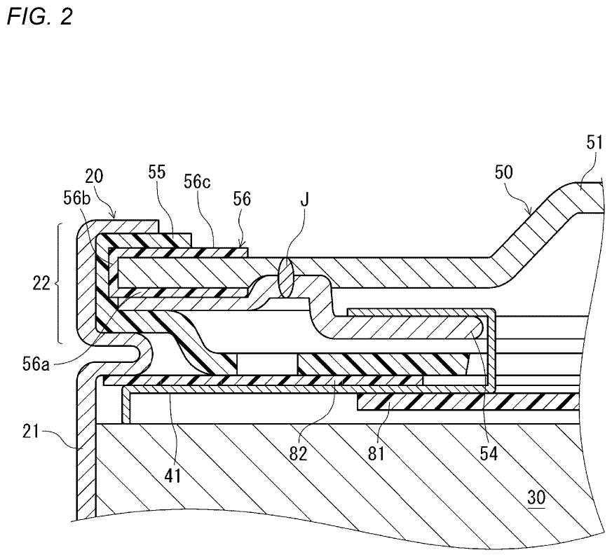

A battery 10 of the present embodiment is configured as a lithium-ion secondary battery, but is not limited thereto. As illustrated in FIGS. 1 and 2, the battery 10 includes a case 20, an electrode group 30, and a sealing unit 50.

The case 20 is formed in a bottomed cylindrical shape having an opening at one end (upper end in FIG. 1) thereof, and includes a side wall 21 formed in a cylindrical shape and a disk-shaped bottom 23. A crimped part 22 that fixes the sealing unit 50 is formed in an area of the side wall 21 in the vicinity of the opening. The case 20 in the present embodiment is constituted of a metal containing iron as a main component, but is not limited thereto.

The electrode group 30 is housed in the case 20, and includes a negative electrode and a positive electrode. The electrode group 30 is a wound electrode group of the negative electrode and the positive electrode, wound with a separator therebetween. The outer shape of the electrode group 30 is cylindrical. The negative electrode is electrically connected to the bottom 23 of the case 20. In the above configuration, the case 20 functions as an external negative terminal. The positive electrode is electrically connected to a current collector plate 54 (described later) of the sealing unit 50 via a positive electrode lead 41. The negative electrode is an example of the first electrode, and the positive electrode is an example of the second electrode.

The sealing unit 50 seals the opening of the case 20. The sealing unit 50 includes a conductive cap 51, a current collector plate 54, and a gasket 55. The conductive cap 51 is constituted of metal and is provided outward of the current collector plate 54 in the axial direction of the case 20. The conductive cap 51 is exposed to the outside of the case 20. The current collector plate 54 is constituted of metal, and is joined to the conductive cap 51 at a first joint J, for example, by welding. Since the current collector plate 54 is electrically connected to the positive electrode of the electrode group 30 as described above, the conductive cap 51 joined to the current collector plate 54 functions as an external positive electrode terminal. The gasket 55 is constituted of an insulative resin, and is provided between the conductive cap 51 and the current collector plate 54 and the crimped part 22.

The sealing unit 50 further includes an insulating member 56 having a melting point or load deflection temperature higher than that of the gasket 55. The insulating member 56 is constituted of a thermal expansion material having a linear expansion coefficient at 25 °C of 2.0×10⁻⁵/K or more, but is not limited thereto. For example, the insulating member 56 may contain ceramics as a main component. The insulating member 56 is provided outward of the first joint J, and includes a first insulating portion 56a, a second insulating portion 56b, and a third insulating portion 56c. The first insulating portion 56a is located between the peripheral edge of the current collector plate 54 and the peripheral edge of the conductive cap 51. The second insulating portion 56b extends in the axial direction of the case 20 (upward in FIG. 1) from the outer peripheral end of the first insulating portion 56a, and is located between the conductive cap 51 and the gasket 55. The third insulating portion 56c extends radially inward of the case 20 from an end (upper end in FIG. 1) of the second insulating portion 56b, and is located between the conductive cap 51 and the gasket 55.

Given that D represents the radial distance from the outer peripheral edge of the conductive cap 51 to the first joint J, the radial distance from the outer peripheral edge of the conductive cap 51 to the inner peripheral end of the first insulating portion 56a is 0.25 D or more, preferably 0.5 D or more, and more preferably 0.8 D or more.

A first insulating plate 81 and a second insulating plate 82 are provided between the electrode group 30 and the sealing unit 50. The first insulating plate 81 is provided closer to the electrode group 30 (lower side in FIG. 1) than the second insulating plate 82. The first insulating plate 81 is provided between the electrode group 30 and the positive electrode lead 41 to prevent contact between the negative electrode of the electrode group 30 and the positive electrode lead 41. The second insulating plate 82 is provided between the case 20 and the positive electrode lead 41 to prevent contact between the case 20 and the positive electrode lead 41.

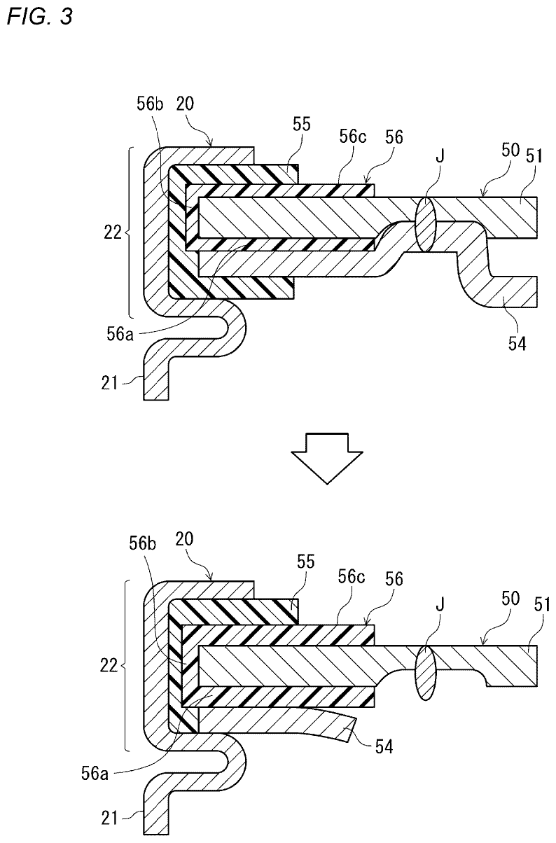

FIG. 3 illustrates states before and after combustion occurs in the battery 10 of the present embodiment. As illustrated in the drawing, when combustion occurs in the battery 10, the gasket 55 may melt to allow the peripheral edge of the current collector plate 54 to come into contact with the case 20. However, in the battery 10 of the present embodiment, the insulating member 56 having a high melting point or load deflection temperature is provided between the peripheral edge of the current collector plate 54 and the peripheral edge of the conductive cap 51. This inhibits electrical contact between the case 20 and the conductive cap 51. Note that an area of the current collector plate 54 near its inner periphery may melt, but may not fully melt in combustion. In the latter instance, there is a risk that the case 20 and the conductive cap 51 are in electrical contact with each other via the first joint J. However, the insulating member 56 of the present embodiment greatly expands by heat of combustion. As a result of the expansion, the joined state at the first joint J is released. As described so far, an internal short circuit in combustion can be inhibited in the battery 10 of the present embodiment.

### SUPPLEMENTAL REMARKS

According to the above description of the embodiments, the following techniques are disclosed.

### Technique 1

A battery including:
a case with a bottomed cylindrical shape having an opening at one end thereof;
an electrode group housed in the case and including a first electrode and a second electrode; and
a sealing unit that seals the opening, wherein
the case includes a crimped part that fixes the sealing unit, and is electrically connected to the first electrode,
the sealing unit includes:
   a current collector plate electrically connected to the second electrode;
   a conducive cap provided outward of the current collector plate in an axial direction of the case and joined to the current collector plate at a first joint;
   a gasket that is insulative and that is provided between the crimped part and the current collector plate and the conductive cap; and
   an insulating member including a first insulating portion located between a peripheral edge of the current collector plate and a peripheral edge of the conductive cap, and
the first insulating portion is provided outward of the first joint.

### Technique 2

The battery according to Technique 1, wherein the insulating member further includes a second insulating portion extending in the axial direction of the case from an outer peripheral end of the first insulating portion and located between the conductive cap and the gasket.

### Technique 3

The battery according to Technique 2, wherein the insulating member further includes a third insulating portion extending radially inward of the case from an end of the second insulating portion and located between the conductive cap and the gasket.

### Technique 4

The battery according to any one of Techniques 1 to 3, wherein the insulating member is constituted of a thermal expansion material having a linear expansion coefficient at 25 °C of 2.0×10⁻⁵/K or more.

### Technique 5

The battery according to Technique 4, wherein given that D represents a radial distance from an outer peripheral edge of the conductive cap to the first joint, a radial distance from the outer peripheral edge of the conductive cap to an inner peripheral end of the first insulating portion is 0.25 D or more.

### Technique 6

The battery according to any one of Techniques 1 to 5, wherein the first insulating portion has a melting point or load deflection temperature higher than that of the gasket.

### Technique 7

The battery according to any of Techniques 1 to 6, wherein the first insulating portion contains ceramics.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### INDUSTRIAL APPLICABILITY

The present disclosure can be used for batteries.

### REFERENCE SIGNS LIST

10: Battery
20: Case
21: Side wall
22: Crimped part
23: Bottom
30: Electrode group
41: Positive electrode lead
50: Sealing unit
51: Conductive cap
54: Current collector plate
55: Gasket
56: Insulating member
56a: First insulating portion
56n: Second insulating portion
56c: Third insulating portion
81: First insulating plate
82: Second insulating plate
L: First joint

1. A battery comprising:
a case with a bottomed cylindrical shape having an opening at one end thereof;
an electrode group housed in the case and including a first electrode and a second electrode; and
a sealing unit that seals the opening, wherein
the case includes a crimped part that fixes the sealing unit, and is electrically connected to the first electrode,
the sealing unit includes:
a current collector plate electrically connected to the second electrode;
a conducive cap provided outward of the current collector plate in an axial direction of the case and joined to the current collector plate at a first joint;
a gasket that is insulative and that is provided between the crimped part and the current collector plate and the conductive cap; and
an insulating member including a first insulating portion located between a peripheral edge of the current collector plate and a peripheral edge of the conductive cap, and
the first insulating portion is provided outward of the first joint.

2. The battery according to claim 1, wherein the insulating member further includes a second insulating portion extending in the axial direction of the case from an outer peripheral end of the first insulating portion and located between the conductive cap and the gasket.

3. The battery according to claim 2, wherein the insulating member further includes a third insulating portion extending radially inward of the case from an end of the second insulating portion and located between the conductive cap and the gasket.

4. The battery according to claim 1, wherein
the insulating member is constituted of a thermal expansion material having a linear expansion coefficient at 25 °C of 2.0×10⁻⁵/K or more.

5. The battery according to claim 4, wherein
given that D represents a radial distance from an outer peripheral edge of the conductive cap to the first joint, a radial distance from the outer peripheral edge of the conductive cap to an inner peripheral end of the first insulating portion is 0.25 D or more.

6. The battery according to claim 1, wherein
the first insulating portion has a melting point or load deflection temperature higher than that of the gasket.

7. The battery according to claim 1, wherein
the first insulating portion contains ceramics.
